(19) United States
(12) Patent Application Publication
(10) Pub. No.: US 2010/0318788 A1
(43) Pub. Date: Dec. 16, 2010

(54) METHOD OF MANAGING SECURE COMMUNICATIONS

(76) Inventors: Alexandro Salvarani, Edison, NJ (US); Ming Huang, Naperville, IL (US); Harvey Rubin, Morristown, NJ (US); Hsien-Chuen Yu, Naperville, IL (US)

Correspondence Address: CARLSON, GASKEY & OLDS, P.C./Alcatel-Lucent, 400 W MAPLE RD, SUITE 350, BIRMINGHAM, MI, 48009, US

(21) Appl. No.: 12/483,525

(22) Filed: Jun. 12, 2009

(51) Int. Cl. H04L 9/32; H04L 9/30

(52) U.S. Cl. 713/156; 380/30

(57) ABSTRACT

An exemplary method of managing secure communications between nodes includes receiving a public key of a node associated with a certification authority. A root node certificate is provided to the node responsive to the received public key. The root node certificate indicates that the received public key belongs to the node. A root self-signed certificate corresponding to a public key of the certification authority is also provided to the node.

### TECHNICAL FIELD

This invention generally relates to communication. More particularly, this invention relates to secure communications.

### DESCRIPTION OF THE RELATED ART

Wireless communication systems are now in widespread use. Increasing use of wireless high speed packet data communications has resulted in radio access networks (RANs) changing from circuit-switched wireless networks to packet-switched wireless networks. This change has been implemented to meet the high capacity demand efficiently and to interface and operate with other packet data networks. With this type of change, the radio access network elements (NEs), such as computers or servers in radio network controllers, base transceiver stations or both along with interfaces between these NEs have been exposed to Internet Protocol traffic.

Exposing such NEs to IP traffic introduces potential security threats and vulnerabilities to the NEs. One approach is to replace existing non-secure communication protocols used by the RAN with secure protocol versions. Examples include secure shell (SSH) and IP security (IPsec). SSH is a known program for logging into another computer over a network to execute commands in a remote machine and to move files from one machine to another, for example. SSH provides strong authentication and secure communications over otherwise unsecure channels. IPsec is a set of protocols developed by the Internet Engineering Task Force (IETF) to support secure exchange of packets at the IP layer.

Such protocols require public key-private key pairs, digital certificates and other credentials to be populated in each network element in the network for supporting strong authentication and public key cryptography. These credentials must be generated, provisioned to the network elements and in general managed in a way that is secure and based on trusted resources. This may be accomplished by manual, out-of-band procedures or an automated process involving an exchange of digital signatures.

Managing such credentials in a large network must be manageable. There is a significant challenge presented in wireless access networks where the network elements that host the security credentials may be numerous. For example, there may be multiple RNCs and hundreds or thousands of BTSs.

Any attempt to manually manage the process of provisioning security credentials to such network elements is undesirable as it introduces additional maintenance cost, reduces operational efficiency and is subject to human error or security breaches. Automated procedures are therefore preferred.

One challenge that must be overcome in a large scale network is how to manage the large number of messages that must be exchanged among the network elements in an automated arrangement. For example, digital certificates are traditionally self-signed certificates generated locally by each network element. The digital certificate may be based on a credential such as the public key of an RSA key pair or a similar cryptographic credential. The self-signed certificate is signed by the private key of the key pair and plays the role of a container to host the public key. Authenticating each node with such an arrangement requires that the self-signed certificates be exchanged in a pair-wise manner. In other words, two exchanges are needed for each secure connection between the network elements.

In the case of a fully mesh network of N nodes, the number of certificate exchanges is equal to N×(N−1) or on the order of N⁻². When there are a large number of network elements, N is a substantially large number and the number of messages required to exchange the certificates becomes unmanageable. Whenever N exceeds 100, for example, the number of messages to be exchanged in a fully mesh network exceeds 10,000. This volume of signaling is undesirable.

There is a need for efficiently managing the security of communications in such a network.

### SUMMARY

Secure communications between nodes (e.g., an IP host) that communicate with each other are facilitated by a trusted certification authority that receives requests from nodes (e.g., a public key) and issues certificates (e.g., an encrypted version of the private key) to the nodes. The nodes use such certificates to authenticate the identity of the peer node with which they are communicating.

An exemplary method of managing secure communications between nodes from the viewpoint of the certification authority includes receiving a public key of a node associated with the certification authority. A root node certificate is provided to the node responsive to the received public key. The root node certificate indicates that the received public key belongs to the node. A root self-signed certificate corresponding to a public key of the certification authority is also provided to the node.

Another exemplary method of conducting secure communications from the viewpoint of at least one of the nodes includes providing a public key of the node to an associated certification authority. The node receives a root node certificate from the certification authority. The root node certificate indicates that the provided public key belongs to the node. The node also receives a root self-signed certification from the certification authority. The root self-signed certificate corresponds to a public key of the certification authority.

An exemplary communication system includes a first certification authority associated with a first plurality of nodes. A second certification authority is associated with a second plurality of nodes. The certification authorities are configured to communicate with each other. Each certification authority provides a root self-signed certificate to the other certification authority. Each root self-signed certificate corresponds to a public key of that certification authority. The certification authorities are configured to certify a root authority certificate received from the other certificate authority. The certification authorities are each configured to provide each associated node with (i) a root node certificate from the certification authority that indicates that a public key received by that certification authority from that node belongs to that node, (ii) the root self-signed certificate from the certification authority and (iii) the certified root authority certificate from the other certification authority.

The various features and advantages of the disclosed examples will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an example communication system.

FIG. 2 is a flowchart diagram summarizing an example approach.

FIG. 3 is a flowchart diagram summarizing an example approach.

### DETAILED DESCRIPTION

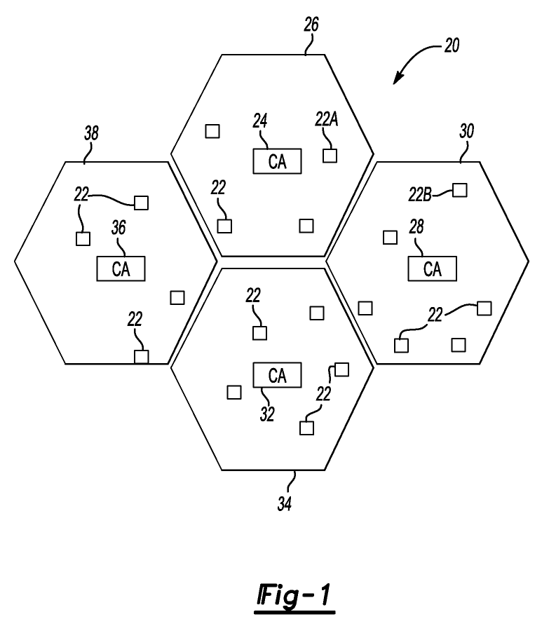

FIG. 1 schematically shows selected portions of a communication system 20. A plurality of nodes 22 are configured for use as part of a wireless communication network. Some of the nodes 22 comprise base station transceivers (BTSs) of a wireless network. Some of the nodes 22 comprise radio network controllers (RNCs). Some of the nodes 22 comprise private or subscriber access nodes (e.g., WLAN or WiFi access nodes). In one example, the nodes 22 are part of a fully mesh network.

For purposes of managing secure communications among the nodes 22, the illustrated example includes a hierarchical delegation arrangement for performing peer authentication.

A first certification authority 24 is associated with a first plurality of the nodes 22 within a security zone schematically shown at 26. A second certification authority 28 is associated with a second plurality of the nodes 22 within a security zone 30. A third certification authority 32 is associated with a third plurality of the nodes 22 within a security zone 34. Similarly, a certification authority 36 is associated with a fourth plurality of the nodes 22 within a security zone 38.

Schematically dividing the distributed nodes 22 into security zones and assigning a certification authority to each zone allows for solving the scaleability problem presented by a large number of nodes that require messaging or exchanging security credentials. The certification authorities communicate with each other and with their associated nodes in a manner that significantly reduces the amount of messages that are required for purposes of exchanging security credentials among the nodes 22.

In one example, the certification authorities comprise devices that are separate from other communication equipment within a corresponding security zone. In another example, a certification authority is configured to be part of a device that has other functions within a communication network. Given this description, those skilled in the art will realize what hardware, software, firmware or combination of them will be useful to provide the functionality of the example certification authorities to meet the needs of their particular situation.

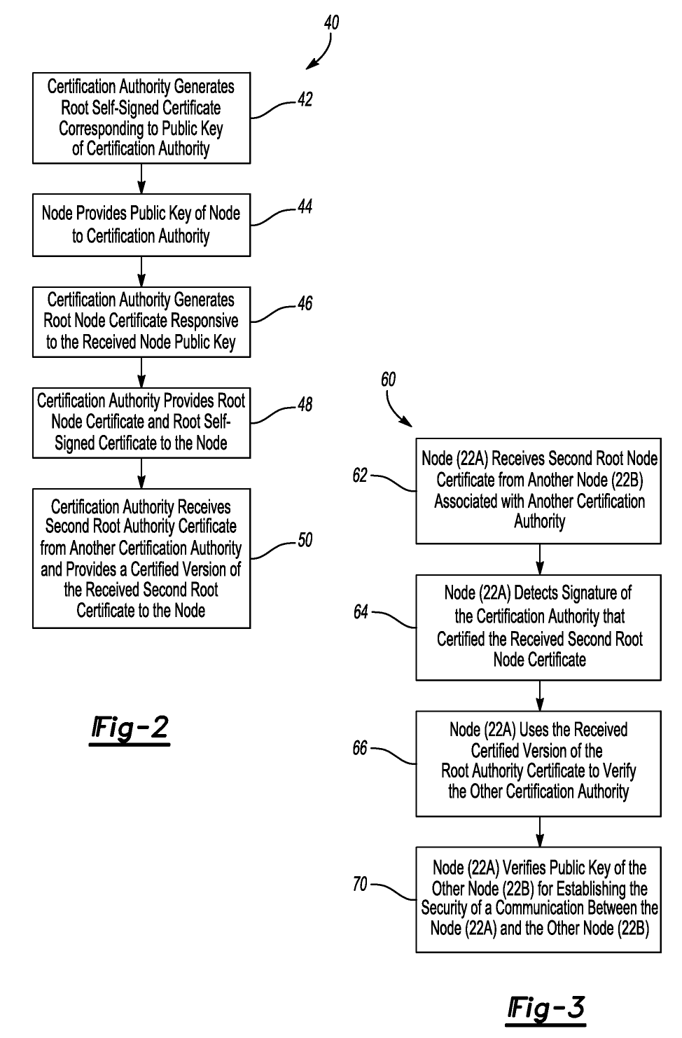

FIG. 2 includes a flowchart diagram 40 summarizing an example approach. At 42, the certification authority for each security zone generates its own root self-signed certificate that corresponds to a public key of the certification authority. In one example, each certification authority uses its own private key for certifying its own public key to each of the nodes 22 associated with that certification authority. That certified version of its own public key is referred to in this description as a root self-signed certificate. The root self-signed certificate comprises the public key of the certification authority that is associated with (i.e., paired to) the private key used for signing the self-signed certificate.

At 44, each node provides its own public key to the associated certification authority. At 46, the certification authority generates a root node certificate responsive to receiving the public key of one of the associated nodes. In one example, the certification authority signs the public key that it receives from an associated node to generate the root node certificate of the node's public key. In other words, the root node certificate comprises the public key of the node signed by the private key of the certification authority.

Each root node certificate is a certification from the associated certification authority that the public key received from that node belongs to that node. At 48, the certification authority provides the root node certificate to the appropriate node 22. Each node receives its own root node certificate. At 48 the certification authority also provides its own root self-signed certificate to each of the associated nodes.

In addition to communicating with the associated nodes 22, each certification authority communicates with the other certification authorities. Each certification authority provides its self-signed certificate to the other certification authorities. As indicated at 50, each certification authority receives a root authority certificate from the other certification authorities. The certification authorities each certify such a received root authority certificate from another certification authority and provide a certified version of it to the associated nodes within its security zone.

When the approach summarized in FIG. 2 is completed, each of the nodes 22 has its own root node certificate, the root self-signed certificate of its associated certification authority and a certified version of any root authority certificates from other certification authorities from other security zones. Given that information, exchanging security credentials among the nodes 22 can be streamlined.

For example, each node 22 in the first security zone 26 has its own root node certificate that it received from the first certification authority 24. Each node 22 in the security zone 26 also has the root self-signed certificate of the certification authority 24. Each node 22 in the security zone 26 also has a certified version of the root authority certificate from the second certification authority 28 (certified by the first certification authority), for example.

Exchanging security credentials among nodes is accomplished in one example as summarized in the flowchart 60 of FIG. 3. For purposes of discussion, a node 22A from the first security zone 26 receives a second root node certificate from one of the nodes 22B in the security zone 30. This is shown at 62 in FIG. 3. In other words, the node 22B sends its public key node certificate signed by the certification authority 28 to the node 22A. At 64, the node 22A detects the signature of the second certification authority 28 that certified the second root node certificate of the node 22B. At 66 the node 22A uses the received certified version of the root authority certificate of the second certification authority 28 (received from the certification authority 24) to verify that certification authority 28. At 70, the node 22A verifies the public key of the node 22B for establishing the security of a communication between them. The node 22B follows the same procedure with the root node certificate received from the node 22A. Then the nodes are ready to authenticate each other.

In some situations, the nodes will be associated with the same certification authority (i.e., within the same security zone). Such nodes need only consider the root self-signed certificate of their common certification authority without needing to consider whether the root node certificate of the other node is signed by a trusted certification authority.

Verifying the public key of the other node may be accomplished in a variety of known manners. For example, the node 22A challenges the public key of the node 22B using known techniques to determine if the node 22B is a valid node. In one example, IPsec is used to determine if the private key pair exists at the node 22B. The node 22B does the same thing to verify the node 22A. Once appropriate verification is achieved, secure communications between the nodes can be accomplished.

It is significant to note that the number of message exchanges required by utilizing the certification authorities and the certificates described above (i.e., a hierarchical delegation) is significantly reduced compared to an arrangement that relies strictly on peer-to-peer credential exchange. As described above, in a traditional mesh network, the number of direct peer-to-peer message exchanges among a total of N nodes would be on the order of N². If the number of certification authorities and security zones is kept relatively low, the number of message exchanges can be reduced to the order of N.

In one example, the number of message exchanges for purposes of exchanging security credentials for establishing secure communications among a total of N nodes is T=N+S(S−1), were N is the total number of nodes, S is the number of certification authorities or security zones and T is the total number of messages exchanged. In the example of FIG. 1, S=4 and the total number of exchanged messages is N+12. This is significantly less than N×(N−1).

Using the certification authorities for hierarchical delegation and relying upon the certificates described above allows the nodes 22 to establish secure communications between them in an efficient and reliable, automated manner. Additionally, the disclosed example allows for network changes such as adding nodes and is scaleable. Certificate management can be automated with minimal human intervention. The reduction in message exchanges improves system performance.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of managing secure communications, comprising the steps of:
receiving a public key of a node associated with a certification authority;
providing a root node certificate to the node responsive to the received public key, the root node certificate indicating that the received public key belongs to the node; and
providing a root self-signed certificate corresponding to a public key of the certification authority to the node.

2. The method of claim 1, comprising
receiving a second root authority certificate from a second, different certification authority, the received second root authority certificate corresponding to a public key of the second certification authority; and
providing a certified version of the second root authority certificate to the node.

3. The method of claim 2, comprising
receiving a plurality of public keys from a corresponding plurality of nodes associated with the certification authority;
providing a root node certificate to each of the plurality of nodes responsive to the received public keys, respectively, each root node certificate indicating that the corresponding received public key belongs to the respective node;
providing the certified version of the second root authority certificate to each of the plurality of nodes; and
providing the root self-signed certificate to the each of the plurality of nodes.

4. The method of claim 2, wherein there are S certification authorities and N total nodes involved in a secure communication, at least one of the N nodes being associated with each of the S certification authorities and the method comprises
exchanging a total of T messages between the N nodes, wherein T=N+S×(S−1); and
conducting the secure communication between the N nodes based upon the T exchanged messages.

5. The method of claim 1, comprising
receiving a plurality of public keys from a corresponding plurality of nodes associated with the certification authority;
providing a root node certificate to each of the plurality of nodes responsive to the received public keys, respectively, each root node certificate indicating that the corresponding received public key belongs to the respective node; and
providing the root self-signed certificate to the each of the plurality of nodes.

6. The method of claim 1, comprising
generating the root node certificate of the received public key of the node at the certification authority, the root node certificate comprising the public key of the node signed by a private key of the certification authority.

7. A method of conducting a secure communication, comprising the steps of:
providing a public key of a node to an associated certification authority;
receiving, at the node, a root node certificate from the certification authority, the root node certificate indicating that the provided public key belongs to the node;
receiving, at the node, a root self-signed certificate from the certification authority, the root self-signed certificate corresponding to a public key of the certification authority associated with a private key used for signing the self-signed certificate.

8. The method of claim 7, comprising
receiving, at the node, a certified version of a second root authority certificate from the certification authority, the second root authority certificate corresponding to a public key of a second, different certification authority that is associated with at least one second node that is distinct from the node.

9. The method of claim 8, comprising
receiving, at the node, a second root node certificate from the second node associated with the second certification authority; and
validating the public key of the second node using the received certified version of the second root authority certificate and the received second root node certificate.

10. The method of claim 9, comprising
recognizing a signature of the second certification authority from the received second root node certificate; and
verifying the signature of the second certification authority using the provided certified version of the second root authority certificate.

11. The method of claim 8, wherein there are S certification authorities and N total nodes involved in a secure communication, at least one of the N nodes being associated with each of the S certification authorities and the method comprises
exchanging a total of T messages between the N nodes, wherein T=N+S×(S−1); and
establishing security for the secure communication based upon the T exchanged messages.

12. The method of claim 11, wherein only the T exchanged messages are necessary to achieve secure communications without any further security set up message exchange between any of the N nodes.

13. The method of claim 7, wherein the received root node certificate comprises the public key of the node signed by a private key of the certification authority.

14. The method of claim 7, comprising
receiving, at the node, a second root node certificate from a second node associated with the certification authority; and
validating the public key of the second node using the received root self-signed certificate and the received second root node certificate.

15. A communication system, comprising:
a certification authority configured to communicate with a plurality of nodes for receiving a public key of each of the nodes and to responsively provide a respective root node certificate to each of the nodes, each root node certificate indicating that the public key belongs to the node from which the certification authority received the public key, the certification authority being configured to provide a root self-signed certificate with each of the root node certificates, the root self-signed certificate being from the certification authority.

16. The system of claim 15, wherein the certification authority is a first certification authority associated with a first plurality of nodes and the system comprises a second certification authority associated with a second plurality of nodes;
wherein
the certification authorities are configured to communicate with each other;
each certification authority provides a root self-signed certificate to the other certification authority, the root self-signed certificate corresponding to a public key of the certification authority;
the certification authorities are configured to certify a root authority certificate received from the other certificate authority;
and the certification authorities are each configured to provide each associated node with
(i) a root node certificate from the certification authority, the root node certificate indicating that a public key received by the certification authority from the node belongs to the node,
(ii) the root self-signed certificate from the certification authority, and
(iii) the certified root authority certificate from the other certification authority.

17. The system of claim 16, wherein the first plurality of nodes are configured to
receive a root node certificate from at least one of the second plurality of nodes; and
validate the public key of the at least one of the second plurality of nodes using the certified version of the received certified root authority certificate of the second certification authority and the received root node certificate from the at least one of the second plurality of nodes.

18. The system of claim 17, wherein the first plurality of nodes are configured to
recognize a signature of the second certification authority from the root node certificate from the at least one of the second plurality of nodes;
verify the signature of the second certification authority using the provided certified version of the root authority certificate.

19. The system of claim 16, wherein there are S certification authorities and N total nodes involved in a secure communication, at least one of the N nodes being associated with each of the S certification authorities and the nodes are configured to
exchange a total of T messages between the N nodes, wherein T=N+S×(S−1); and
establish security for the secure communication based upon the T exchanged messages.

20. The system of claim 16, wherein the root node certificate of each node comprises the public key of the node signed by a private key of the associated certification authority.
